(19) United States
(12) Patent Application Publication
(10) Pub. No.: US 2024/0257250 A1
(43) Pub. Date: Aug. 1, 2024

(54) INVESTMENT PLATFORM

(71) Applicant: ATPHIZYOM LIMITED, Hong Kong (CN)

(72) Inventor: Hon Wai Adam TSO, Hong Kong (CN)

(73) Assignee: ATPHIZYOM LIMITED, Hong Kong (CN)

(21) Appl. No.: 18/002,138

(22) PCT Filed: Jul. 15, 2022
(86) PCT No.: PCT/IB2022/056522

§ 371 Date: Dec. 16, 2022

(30) Foreign Application Priority Data
Jul. 16, 2021 (HK) 32021035125.2

(51) Int. Cl. G06Q 40/06

(52) U.S. Cl. CPC G06Q 40/06

(57) ABSTRACT

There is provided a computer based method and system generating for a specified user an optimised portfolio comprising a plurality of investable financial instruments. Criterion from the user for selecting financial instrument(s) from a plurality of investable financial instruments is acquired. Social interaction data characterising interactions of the user with other users and informational interaction data are used by a first machine learning model to rank potentially investable financial instruments of the platform according to a first score. A second machine learning model generates a portfolio comprising a plurality of investable financial instruments for the user having a first score from criterion, social interaction data, artificial intelligence model & machine learning module interaction data and informational interaction data of the user encrypted on a distributed ledger. Optionally, a gamification module and/or rewards module may be further included.

### CROSS-REFERENCE TO RELATED APPLICATIONS

This application is a national phase application of International Application No PCT/IB2022/056522, filed Jul. 15, 2022, which claims priority to Hong Kong Patent Application Serial No. 32021035125.2, filed Jul. 16, 2021, all of which are incorporated herein by reference.

### BACKGROUND

The present disclosure relates generally to a method, system and process of a computer based investment platform for improving investment in and selection of investable financial instruments for individuals, which may include without limitation stocks, bonds, currencies, commodities (e.g. gold, silver, etc.), derivatives, futures, investment funds, fixed-income securities, cryptocurrencies, digital assets or similar.

Advantageously, the investment platform may be implemented using distributed ledger technology (e.g. Blockchain technology) and artificial intelligence interconnecting users across communication network(s).

Many “autonomous” investing platforms include algorithms which attempt to optimise individual asset selection and allocations for improved performance from an investable universe of investments available, generating an “optimum” portfolio for an individual derived by algorithms using inputs from responses to a standard questionnaire. Typically such algorithms attempt to reach so-called Pareto Optimality—a state of allocation of resources from which it is not possible to reallocate resources to make any performance criterion better without making at least one other performance criterion worse off. In this state it is not possible to improve one variable without harming the other variables.

However, in practice, such approaches typically result in the misallocation or narrow selection from particular types of investable instruments (such as ETFs or exchange traded funds) due to relatively simplistic optimisation algorithms which operate on a narrow set of permissible responses to questions of the questionnaire. For example, the use of overly broad criteria such as risk tolerance, or generalised growth assumptions for classes of assets are commonly used to propose investment for an individual's funds in broad categories of investable instruments which are specified as suitable, thereby “generalising” an individual investor to a generic “class” of investor.

Unfortunately, in this process, a significant amount of information about the individual's preference and the investable instruments themselves is lost through the use of categories, broad criteria and algorithms utilised. Furthermore, as the questionnaires used in this process are somewhat generic and typically capture objective responses, many individual subjective preferences and interests are not used in the allocation of funds of an individual in the investment process as these are not captured.

Furthermore, even if a selection of an asset and/or allocation for an investors funds is optimised at a particular point in time, as investment is a dynamic process, the static allocations of individual investor funds to specific investable instruments in one set of market conditions at a specific point in time needs to change along with changes in an individual's circumstances and/or market fluctuations.

In addition, to many individuals investments in assets and portfolios can be somewhat “dry” and not engaging, and once such an allocation is generated, many individuals lose interest in ongoing monitoring of their investments.

Accordingly, true optimisation is not achieved by such “autonomous investing platform”, which instead are effectively automatic investing allocations based upon broad and pre-conceived categorisation via general algorithms. Illustrative of this outcome is the observation that individuals with entirely different underlying factors can end up with similar allocations to generic investment instruments (such as ETFs, i.e. Exchange-Traded Funds) despite significant differences. Accordingly, this allocation process is constrained, and given the vague and demoralising experience investors feel further disempowered and disengaged from asset allocation and asset selection process.

It is an object of the present method, system and computer readable medium to address or at least partially ameliorate some of the above problems of the current approaches.

### SUMMARY

Features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims.

In accordance with a first aspect of the present disclosure, there is provided a computer based method of generating for a specified user an optimised portfolio comprising a plurality of investable financial instruments; the method comprising acquiring via a user device, criterion from the specified user for selecting one or more financial instruments from a plurality of investable financial instruments on the platform; capturing by a network device, social interaction data characterising interactions of the specified user with other registered users of the platform having investable financial instruments associated therewith for a predetermined period; acquiring by a network device, informational interaction data characterising interactions of a device of a registered user with information about one or more of the plurality of investable financial instruments within the predetermined period; continuously ranking by a first machine learning model operating on a network device each of the plurality of potentially investable financial instruments of the platform according to predetermined objective criteria by generating a first score; generating by a second machine learning model of the platform a portfolio comprising a plurality of investable financial instruments for the specified user by combining the first score for each investable financial instrument with the criterion, social interaction data and informational interaction data of that specified user.

The informational interaction data of the specified user may be derived by monitoring one or more of the parameters selected from a group comprising: searches conducted for a financial instrument by the specified user, and/or time spent by the specified user on specific parameters associated with one or more financial instruments selected from the group comprising one or more of market capitalization, volatility, trading volume, sector/industry, financial metrics. It would be appreciated by a person skilled in the art that similar metrics other than those listed could also be used without departing from the scope of the present disclosure.

The social interaction data may comprise data selected from rate/count over a predetermined time period of interactions with any data selected from the group comprising platform asset(s), portfolio(s), watchlist(s), social interactions with other registered user profiles; and the interactions may comprise clicks, adds, shares, following or followed updates. It would be appreciated by a person skilled in the art that similar metrics other than those listed could also be used without departing from the scope of the present disclosure.

The second machine learning model may be further configured to receive data from a gamification module incentivising participation in a plurality of tasks by awarding points to an account associated with the specified user. The plurality of tasks may be selected from the group comprising one or more of relative improvement in performance of portfolio to other users, absolute performance of portfolio, relative improvement in social media engagement to other users, absolute improvement in social media engagement relative to other users, and performance in one or more games.

One or more of the social interaction data and informational interaction data are stored on an underlying decentralized distributed ledger. Tokens on an underlying decentralized distributed ledger are updated by a rewards module according to points awarded by the gamification module for a specified user for performance of predetermined tasks. Tokens on an underlying decentralized distributed ledger may be updated by a rewards module upon a corresponding payment of an amount of predetermined currency from an account of the specified user.

One or more of the social information data and/or informational interaction data may be encrypted.

In a further aspect there is provided a system for generating for a specified user an optimised portfolio comprising a plurality of investable financial instruments; the system comprising an interface module for generating an interface for acquiring via a user device, criterion from the specified user for selecting one or more financial instruments from a plurality of investable financial instruments on the platform; a social network module of a network device for capturing social interaction data characterising interactions of the specified user with other registered users of the platform having investable financial instruments associated therewith for a predetermined period; an informational interaction data module configured for capturing interactions of a device of a registered user with information about one or more of the plurality of investable financial instruments within the predetermined period; a first machine learning model operating on a network device for continuously ranking each of the plurality of potentially investable financial instruments of the platform according to predetermined objective criteria by generating a first score; a second machine learning model operating on a network device for optimising a portfolio comprising a plurality of investable financial instruments for the specified user by combining the first score for each investable financial instrument with the criterion, social interaction data and informational interaction data of the user.

Optionally, the informational interaction data module captures interactions of the specified user by monitoring one or more of the parameters selected from a group comprising: searches conducted for a financial instrument by the specified user, and/or time spent by the specified user on specific parameters associated with one or more financial instruments selected from the group comprising one or more of market capitalization, volatility, trading volume, sector/industry, financial metrics. It would be appreciated by a person skilled in the art that similar metrics other than those listed could also be used without departing from the scope of the present disclosure.

The social network module may be configured for capturing social interaction data wherein the interactions are selected from the group comprising rate/count over a predetermined time period of clicks, adds, shares, following, followers of any data selected from the group comprising one or more of platform asset(s), portfolio(s), watchlist(s), social media, social network and user follower-following. It would be appreciated by a person skilled in the art that similar metrics other than those listed could also be used without departing from the scope of the present disclosure.

The second machine learning model may be further configured to receive data from a gamification module incentivising participation in a plurality of tasks by awarding points to an account associated with the user.

The plurality of tasks may be selected from the group comprising one or more of relative improvement in performance of portfolio to other users, absolute performance of portfolio, relative improvement in social media engagement to other users, absolute improvement in social media engagement relative to other users, and performance in one or more games. It would be appreciated by a person skilled in the art that similar metrics other than those listed could also be used without departing from the scope of the present disclosure.

One or more of the social information data and/or informational interaction data of the user may be encrypted and stored on a distributed ledger.

Tokens on the underlying decentralized distributed ledger may be updated by a rewards module according to points awarded by the gamification module for a specified user for performance of predetermined tasks.

Tokens on the underlying decentralized distributed ledger may be updated by a rewards module upon a corresponding payment of an amount of predetermined currency from an account of the user.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings.

Preferred embodiments of the present disclosure will be explained in further detail below by way of examples and with reference to the accompanying drawings, in which:—

FIG. 1a shows a schematic representation of the elements of an embodiment of the investment platform of the present disclosure.

FIG. 1b shows a schematic representation of the elements of an embodiment of the investment platform of the present disclosure with optional gamification elements.

FIG. 1c shows an exemplary alternate schematic representation of the embodiment of the investment platform of the present disclosure.

FIG. 1d shows an exemplary algorithm for machine learning cycles with reference to the embodiment of the investment platform depicted in FIG. 1c.

FIG. 2a shows an exemplary representation of an exemplary graphical user interface used to capture user investable criteria and preferences (volatility).

FIG. 2b shows an exemplary representation of an exemplary graphical user interface used to capture user investable criteria and preferences (financial metrics).

FIG. 2c shows an exemplary representation of an exemplary graphical user interface used to capture user investable criteria and preferences (regions/countries).

FIG. 2d shows an exemplary representation of an exemplary graphical user interface used to capture user investable criteria and preferences (size and liquidity).

FIG. 2e shows an exemplary representation of an exemplary graphical user interface used to capture user investable criteria and preferences (investment horizon).

FIG. 2f shows an exemplary representation of an exemplary graphical user interface used to capture user investable criteria and preferences (asset class).

FIG. 2g shows an exemplary representation of an exemplary graphical user interface used to display optimized and personalized manipulatable algorithmic output of machine learning cycles with reference to user investable criteria and preferences (asset scores & rankings).

FIG. 2h shows an exemplary representation of an exemplary graphical user interface used to display optimized and personalized manipulatable algorithmic output of machine learning cycles with reference to user investable criteria and preferences (portfolio scores & rankings).

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without departing from the spirit and scope of the disclosure.

The disclosed technology addresses the need in the art for an intuitive and engaging investment platform for optimising asset allocation and investments incorporating parameters received from the user, specific asset parameters and ongoing metrics derived from interactions with other users and of the specified user with financial information. Further inputs may include relative user performance of the specific user relative to other users in terms of portfolio performance, social network interactions and outcomes of games played by the users in the specified system.

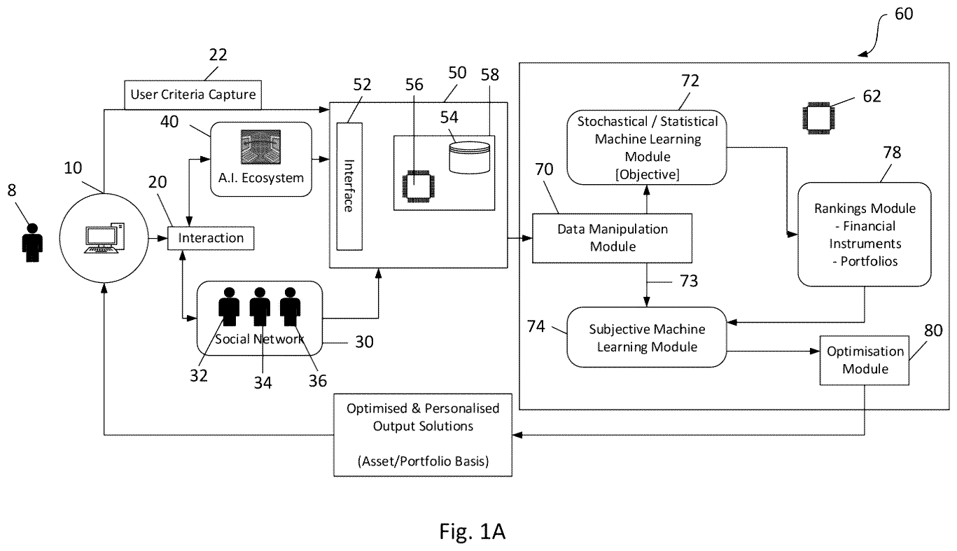

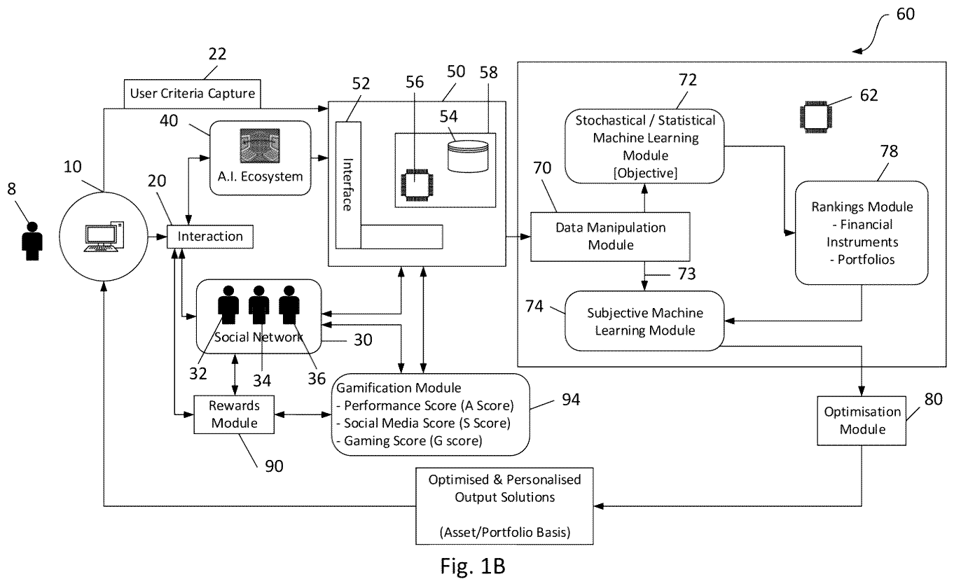

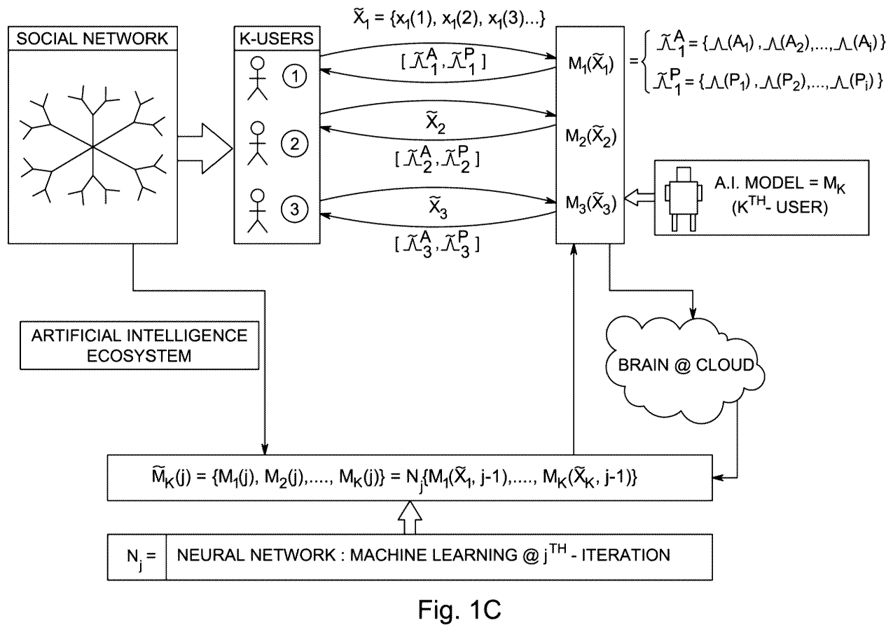

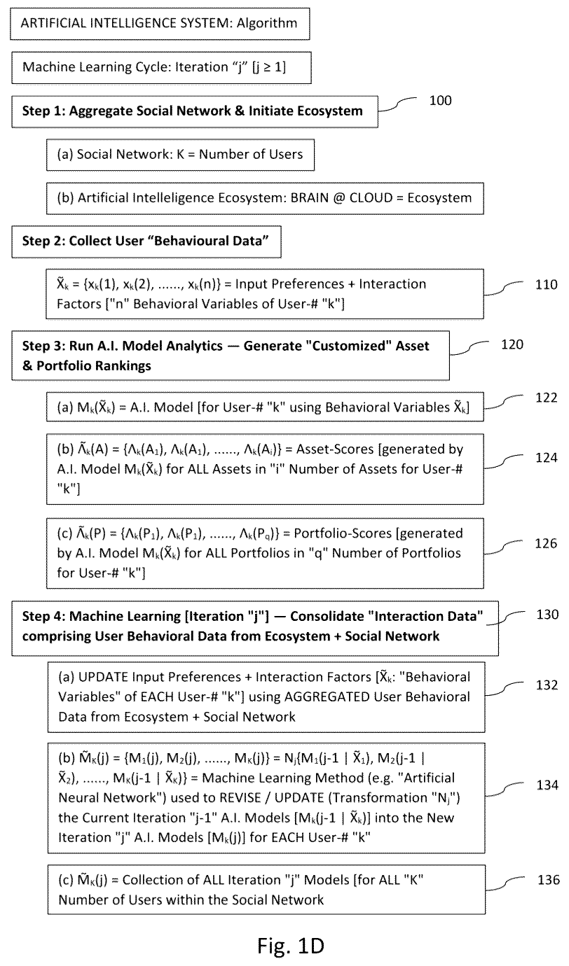

Referring to FIG. 1a, there is depicted a schematic architectural diagram of an embodiment of the platform of the disclosure, which is described in outline below.

As depicted, a platform user 8 having a profile on the platform is authenticated and operates a device 10 has a variety of interactions 20 within the platform, within the social network 30 and within the eco-system 40.

Advantageously, data is captured for each user characterising the interactions of that user with other users and with the electronic information in the ecosystem on a continuous basis via the interface 52 of the processor of the data collection module 50 and may be stored on the data store or database 54. Optionally, the social information data and/or informational interaction data may be encrypted and stored on a distributed ledger in communication with the server underlying the ecosystem or social network.

Advantageously, the ecosystem provides a globally digitalized “symposium” for the mutual exchange of advice & ideas amongst the general population. Advantageously, the ecosystem comprises: Social Network: Platform Users & Social Network Participants, Models—Artificial Intelligence & Machine Learning Modules [i.e. “Bots”, “Smart Assistants”, etc.].

A.I.-Blockchain Network & A.I.-Blockchain-driven Software-as-a-Service [AIBSaaS] platform includes a decentralized & distributed encrypted network software system where platform users' private behavioural & usage data, preferences, social interactions, personalized A.I. Models and Machine Learning Modules are stored and transmitted, and where corresponding related network services are operated on, all of which occur securely over a publicly unsecured network via Blockchain technology utilizing encrypted “Smart Contracts” via various cryptographic network protocols.

Advantageously, the components of this ecosystem are interconnected in a symbiotic relationship to provide interconnection, interaction & interrelation.

In particular, it would be appreciated that users (via the user electronic device 10) have interactions with other users 32, 34 on the social network 30 operating their electronic devices; and at least some of these users may have a stored association with one or more financial instruments. Optionally, the users may also have interactions with a financial instrument or social media feature 36 created on the social network by any of the other platform users, e.g. another user's assets, portfolios, watchlists, followers on the social network 30; or another user's follower/following-users on the social network 30, followed News/Media, followed assets/portfolios/watchlists, etc. It would be appreciated by a person skilled in the art that similar metrics other than those listed could also be used without departing from the scope of the present disclosure.

Similarly, the interaction by the user 10 with information about a financial instrument are monitored and collected by the data collection module 50 where such interaction takes place within the ecosystem 40.

Finally, information about the user's specific circumstance and subjective preferences or criterion for investment and objective qualities pertaining to financial instruments and investments is also captured via an interface 22 and stored and associated with their corresponding user record on the data store 54 by the data collection module 50, which may be operable by a processor 56 of one or more servers 58.

Information either objective (quantitative data and financial metrics pertaining to financial instruments and investments specified criterion) or subjective (user specified criterion and preferences for investment and financial instruments, interactions with other users or within the ecosystem) which is associated with a user record can then be parsed and manipulated by a data manipulation module 60 comprising a processor 62 according to standard stochastic approaches to minimise noise from the data and ensure that it is in an appropriate format.

Optionally one or more of the social information data and/or informational interaction data are encrypted and stored on a distributed ledger.

As appropriate, captured objective information may then be passed to stochastic/statistical machine learning module 72 which is configured for processing the data according to certain stochastic/statistical rules.

These may include a suite of proprietary statistical algorithmic processes known as “Stochastic Rectification”, including “Numerical Volatility Sequencing” which allows for filtering of asset behaviour and isolation of assets by stochastic volatility as will be discussed further below herein. In addition, through the use of “Numerical Sharpe-Ratio Sequencing”, the asset quality may be ranked and ordered as is described in further detail herein.

Such information may then be ranked by a rankings module and then passed to a “subjective” machine learning module 74.

Captured subjective information 73 from the social network, ecosystem and user criteria capture may also be passed to a “subjective” machine learning module 74 which is configured to process recorded data of interactions together with information from the rankings module according to training which is disclosed in more detail below.

Advantageously, both types of information are analysed to prepare scores and ranking of financial instruments which collectively then comprise portfolios.

An optimisation module 80 may be configured to exclude portfolios or assets which fall below a predetermined threshold (e.g. outside the Top-10, Top-20, Top-50 etc.) or do not qualify in satisfying the users' pre-defined criterion or preferences (e.g. asset volatility less than 20%, average trading volume more than US$1 million, etc.), and the resultant optimised and personalised financial instruments and portfolios generated for each user are transmitted for display to the user.

Where a user is reviewing optimisation information at a portfolio level, and has initially only supplied specific assets and/or a target portfolio value (discussed below), “optimized” portfolio asset weights are calculated for the user by the optimisation module via a set of proprietary algorithms which include the respective application of a sequence of proprietary stochastic techniques, namely, “Azeotropic Rectification”, “Monte Carlo Portfolio Simulation”, “Stochastic Rectification” [Numerical Volatility Sequencing+Numerical Sharpe-Ratio Sequencing] and lastly finishing with a “Switch-Gradient Portfolio Optimisation” algorithm configured for obtaining either a Maximum Sharpe-Ratio or a Maximum Return for a user-specified portfolio as is discussed further herein.

Optionally, the asset weights may further be optimised by using the Minimum Acceptable Portfolio Value [MAPV], Target Portfolio Value [TPV] and Recommended Minimum Portfolio Value [RMPV] system platform application features & functionalities which utilize proprietary non-linear portfolio value optimisation algorithms in the optimisation module as discussed further below.

Alternatively, if the user is reviewing the optimisation module on their portable electronic device and/or computer device, and is seeking optimised asset rankings according their specified criteria, the stochastic optimization results, analytics and relevant diagnostic information may be presented for individual assets.

### Getting User Input Criterion and Values

Advantageously, via various features and functionalities within a digital interface of an application hosting on a mobile or other personal electronic device connected over a communications network with the platform, users can provide a set of pre-defined input parameters for their investment preferences and risk-tolerance levels (which provides broad financial parameters, unique to each user) in the process of user information capture 70.

Advantageously, in discovering these parameters the user may specify one or more of the following exemplary parameters of interest from the potentially investable financial instruments:
ASSET-CLASS [Stocks/Currencies/Cryptocurrencies/ETFs/Indices],
REGION [Country/Exchange],
SIZE & LIQUIDITY [Market-Capitalization/3-Month Average Daily-Volume/ANY],
INVESTMENT HORIZON [Time Period: Minimum 2-Weeks, DEFAULT 6-Months],
AVERAGE %-PRICE MOVEMENT ACCEPTABLE [For Investment Horizon/ANY],
FILTER [Financial Metrics/Sector/Industry].

It would be appreciated that the above criterion for investable assets are exemplary only, and a person skilled in the art would appreciate that alternative and/or additional parameters constituting the user criterion may also be supplied.

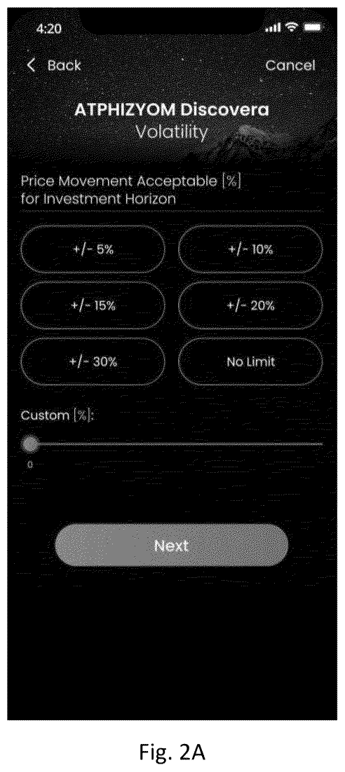

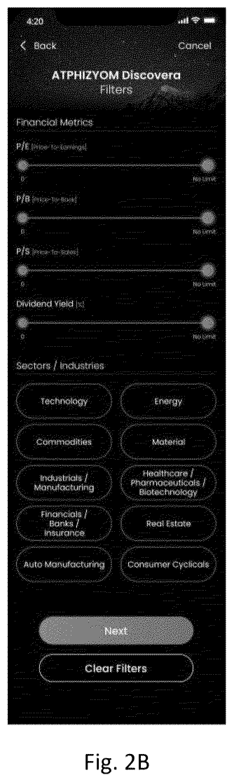

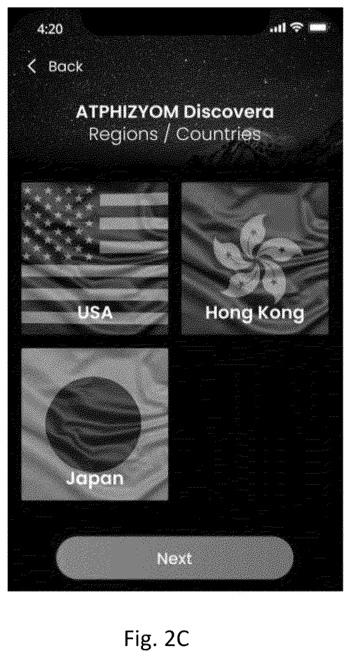

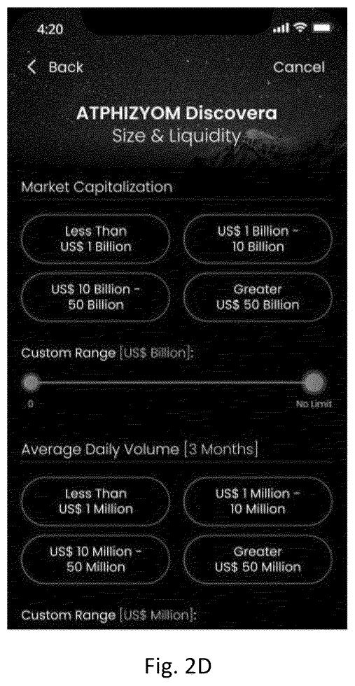

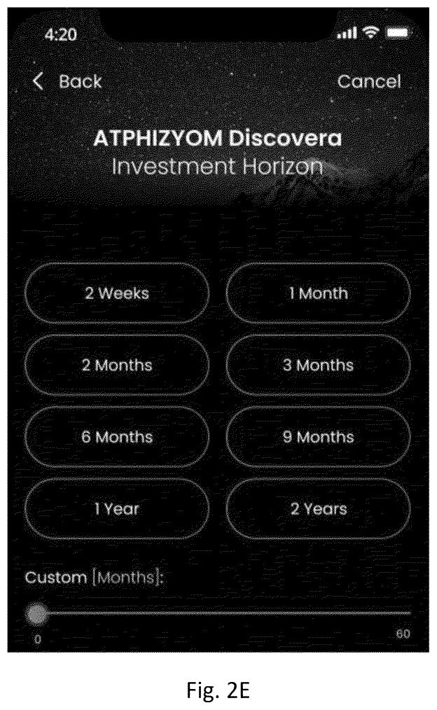

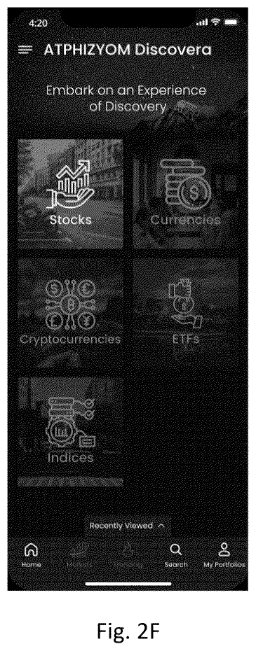

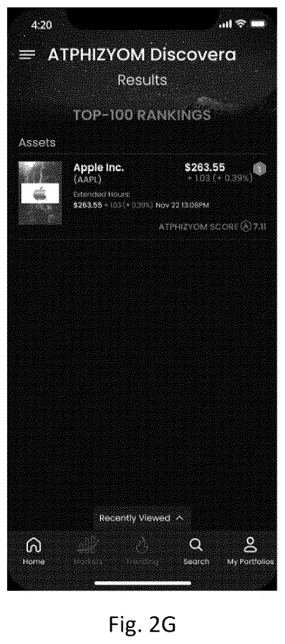

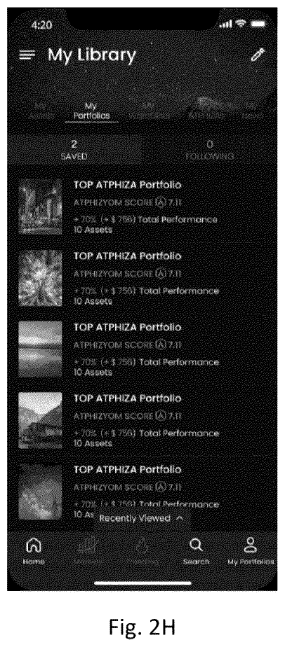

An exemplary interface used for capturing some of these user parameters is depicted in FIGS. 2a-2h.

In some examples, the interface is generated by an interface module. The interface is preferably a graphical user interface. The interface module may configure the graphical user interface to acquire at least one criterion from the user for selecting one or more financial instruments or portfolios from a plurality of investable financial instruments or portfolios on the platform. The interface module may configure one or more input fields, forms, tables or areas of the graphical user interface to receive input from the user. The interface module may be configured to display guidance to prompt the user to input the correct criterion. The guidance may be in the form of text instructions, pre-filled fields and/or forms, selectable options, etc.

Through these interfaces, the user may specify particular user parameters such as preferred volatility (FIG. 2a), financial metrics (FIG. 2b), regions/countries (FIG. 2c), size and liquidity (FIG. 2d), investment horizon (FIG. 2e) and asset class (FIG. 2f) in order to generate optimized and personalized asset scores & rankings (FIG. 2g) and portfolio scores & rankings (FIG. 2h).

It would be appreciated that these interfaces and fields captured are exemplary only, and additional/alternative metrics could also be captured without departing from the present disclosure.

Optionally, the users may explore the possible asset types available; marking those of interest by including information in a Query Engine

```
●  GENRE/SECTOR [User Selection: Country / Exchange]
  ◯  Technology
  ◯  Energy- Commodities/Materials
  ◯  Industrials / Manufacturing- Healthcare / Pharmaceuticals / Biotechnology
  ◯  Financials / Banks / Insurance / etc.
  ◯  ALL SECTORS
●  INDUSTRY [User Selection: Country / Exchange]
●  REGION: HONG KONG, UNITED STATES, JAPAN, ETC.
●  ASSET-CLASS: STOCKS / CURRENCIES / CRYPTOCURRENCIES / ETFS / INDICES
●  MOOD: RISKY / MEDIOCRE / RELAXED / CONSERVATIVE
```

In some examples, the interface module may configure the graphical user interface according to a user class of the user. For example, certain classes of users may be designated as “Premium” or “Pro” users, with additional permissions and/or privileges. In some examples, the graphical user interface may be configured for the selection of a set of asset classes according to the designated user class. For example, the interface module may configure the one or more input fields, forms, tables or areas of the graphical user interface to receive the selection of a specific set of asset classes according to the designated user class of the user. The graphical user interface may be configured not to allow the selection of assets which are not part of the set of asset classes corresponding to the user class.

In an example, the interface module may determine that a user class of the user is a “Basic” class and configure the graphical user interface to allow the selection of a limited set of asset classes, e.g. stocks only. In another example, the interface module may determine that the user class of the user is a “Premium” or “Pro” class and configure the graphical user interface to allow the selection of all asset classes, e.g. stocks, bonds, currencies, commodities, derivatives, futures, investment funds, cryptocurrencies, digital assets, etc.

Similarly, in other examples the interface module may configure the graphical user interface to allow or restrict the selection of any parameters according to the user class. For example, the interface module may determine that a user class of the user is a “Basic” class and configure the graphical user interface to allow the selection of a “relaxed” or “conservative” mood only with respect to financial instrument or portfolio characteristic parameters. In another example, the interface module may determine that the user class of the user is a “Premium” or “Pro” class and configure the graphical user interface to also allow the selection of a “risky” or “mediocre” mood with respect to financial instrument or portfolio characteristic parameters. Optionally, the user specified criteria may further be analysed by carrying out rectification processes as described below.

### Social Interaction Data

As outlined above, registered users of the platform may create relationships with each other and/or with investable instruments on the platform.

For example, a user may follow another user having a common interest in certain types of investable assets (e.g. gold stocks). It would be appreciated that the followed/follower data would be associated with each user and stored on the platform, advantageously on a central server and continuously updated based upon the interactions between the registered users.

This analytical data can include information such as posts, views, likes/dislikes, emojis, comments, membership of groups/communities, following, followed etc. It would be appreciated by a person skilled in the art that similar metrics other than those listed could also be used without departing from the scope of the present disclosure.

Alternatively, and/or in addition, registered users may choose to enter into a specified relationship with potentially investable instruments on the platform using pre-defined platform “actions/functions”, (e.g. Follow Portfolio, Add Watchlist to “My Watchlist Collection”, Add Asset to “My Asset Collection”, Share Portfolio to another User, etc.). Again, this data is advantageously associated with a specified user and stored on a central server as described above or may be encrypted and stored on a decentralized & distributed ledger.

Each Platform User individually has a private set of personal data fields that capture the user's individual behavioral data, usage patterns, social interactions, personal preferences, etc. such as a few of the following non-exclusive examples of data variables captured and stored on the database platform:

Interactions between the users and/or associated assets are captured using various proprietary metrics including without limitation:
>Asset Clicks/Adds/Shares/Follows/Followers [Rate/Count]
Rate/Count of Frequency an Asset has been Clicked (i.e. “Viewed”), e.g. ClicksAAPL (k)=Number of Times “Apple Stock” (Ticker Symbol=AAPL) was Clicked/Viewed by User “k”. This dynamic variable can be used as one of the multitude of input Machine Learning variables used to Train & Validate the artificial intelligence models built and updated in real-time continuously to generate output indicators that could be in turn used to deduce pattern-recognitions correlated with the individual User's asset investment behavior and preferences. This allows the A.I. Ecosystem to provide relevant asset and/or portfolio suggestions.
>Portfolio Clicks/Adds/Shares/Follows/Followers [Rate/Count]
Rate/Count of Frequency a Portfolio has been Added (i.e. “Copied/Stored”), e.g. Adds_{Portfolio-j} (k)=Number of Times “Portfolio-j” created/owned by User “k” was Added/Copied by other Platform Users to their own Portfolio Collections.
This dynamic variable can be used as a Machine Learning input variable to build A.I. Models that can infer or deduce social media popularity patterns correlated to the individual User “k”, as well as portfolio performance correlations with specific genres of “Assets of Interest” relevant to User “k”.
>Watchlist Clicks/Adds/Shares/Follows/Followers [Rate/Count]
>User Profile Follows & Followers [Rate/Count]
Binary Marker (Yes/No=1/0) for the “Followed Status” of another Platform User indicating if he/she has been Followed (i.e. “Connected”) by another Platform User, e.g. Follow _{User-i}(k)=1 indicates User “k” is FOLLOWING “User-i”. This Binary Marker can be used to assimilate Assets & Portfolios from other relevant “Users of Interest” which the individual User has chosen to connect with.

Specifically, in the user profile that is established for each user, these fields may be captured to build up a complete profile of the social interactions of that specified user. It would be appreciated that the data collected on each specified user may be segmented to a specific predetermined time period, for example one day, one week or one month. It would be appreciated by a person skilled in the art that similar metrics other than those listed could also be used without departing from the scope of the present disclosure.

### Technology Platform Underlying the Social Network Aspect

Advantageously, the social network may be constructed upon a proprietary blockchain network in an exemplary embodiment in order to maximize the social Network's network-efficiency and cyber-security.

This also enhances the overall platform scalability, by utilising a “composite” approach of leading blockchain techniques, in particular a combination of Proof-of-Work [PoW] and Proof-of-Stake [PoS], to implement the aforementioned blockchain network specifically for the social network embedded in the A.I.-Ecosystem-based investment platform as is discussed further herein. However, since all tokens in the network have been fully-created at the inception of the Platform, there will be no more new cryptocurrency that can be “mined” once the network platform is launched. As a result of this token network architecture, despite the “composite” blockchain approach, the underlying blockchain protocol advantageously has a slightly more skewed resemblance towards a PoS-System Network rather than a PoW-System Network.

In the first-stage of the Blockchain's “Forging (Mining)” process a Proof-of-Stake [PoS] methodology may be used. Any one of the social network users can choose to join the Validator Pool. From there, a select group of Validators, defined by a percentile-metric called the “Forger Threshold”, is chosen to form the Forger Pool. The “Forger Threshold” represents the TOP-1% Largest Stake Token-Holders, and therefore inducts the users into the Forger Pool based on the size of their stakes. Once the Forger Pool is confirmed for the specific round of the blockchain process (every NEW Block will trigger a NEW “Forger Pool” selection), the “Block” Verification process begins and all Forgers participate in the same computation to verify the corresponding transaction(s) between the nodes.

In a second-stage of the Blockchain's “Forging (Mining)” process a Proof-of-Work [PoW] methodology may be used. Once the Forger Pool has successfully completed the “Block” Verification process, the “Block-Creation” Encryption process begins and all Forgers participate in a cryptographic hash algorithm computational speed-race to encrypt the corresponding transaction(s) based on a certain predefined Difficulty-Threshold level for that specific block-creation round (every NEW Block will trigger ONLY ONE winning “Forger” selection for the “Block-Creation” Encryption phase).

Set out below is a typical outline of a cryptographic network protocol for the aforementioned blockchain network detailing how it may be configured for operation of the exemplary social network.

FORGER “Block” Verification & Reward Protocol [Proof-of-STAKE]:
Node: Token Purchase/Usage

| | |
|---|---|
| PURCHASE Criterion: | Increments of “X” Coins/Tokens |
| USAGE Criterion: | Decrements of “Y” Coins/Tokens |
| TASK Criterion: | VERIFICATION of Purchase + Usage |
| COMMISION Fee: | 0.1 A ATPHIZYOM Coin/Token “Unit” |

Node(s) & Node-Portfolio: Challenge-Response

| | |
|---|---|
| TRIGGER Criterion: | Increments of 50 FOLLOWERS |
| PAYOUT Criterion: | Increments of 1 A Coin/Token “Unit” |
| TASK Criterion: | VERIFICATION of Trigger + Payout |
| COMMISION Fee: | 0.1 A Coin/Token “Unit” |

FORGER “Block-Creation” Encryption & Reward Protocol [Proof-of-WORK]:
Encryption: Public-Private Key + Cryptographic Hash

| | |
|---|---|
| PUBLIC-PRIVATE Key: | Modular Multiplicative Inverse |
| HASH Algorithm: | SHA-256 |
| DIFFICULTY Threshold: | Z Level |
| CHALLENGE Criterion: | FIRST “Nonce” Solution for BLOCK- |
| RESPONSE Reward: | BONUS +0.1 A Coin/Token “Unit” |

Advantageously, the combination of POW and PoS may be used to enhance security.

From the “Proof-of-Work” system aspect of the Blockchain Network and Social Network, bad actors are inhibited due to technological and economic disincentives. In fact, a person skilled in the art would appreciate that programming an attack on a PoW-System Network is very expensive, and can hypothetically require a much larger amount of capital and resources than what one can personally afford or subsequently obtain as reward. In contrast, an insecure and simplified “Proof-of-Stake”-based network, without penalties especially, could theoretically be cheaper to attack.

Nonetheless, with an underlying secure PoS-algorithm, a “Proof-of-Stake”-based network could potentially be relatively much safer and harder to infiltrate. In particular, the “PoS-System Network” characteristic of the Blockchain Network and Social Network acts as a natural Intrusion Prevention System [IPS] that safeguards against specific threats and cyber-attacks like 51% Attacks.

Overall, the “Proof-of-Stake” process secures the network and gradually produces new coins (the underlying digital currency or protocol token) over time without consuming significant computational power. As a result of this intrinsic lack of need for large computing power from centralized mining pools, anyone and everyone is capable of participating in the POS-Mining process since it is based purely on the prerequisite “Stake” criteria, thereby ensuring diversity and dispersion of Miners throughout the overall network.

As a further enhancement of the “PoS-System Network” aspect a secondary (auxiliary) protocol to safeguard primary systems—such as enforcing a “Penalty” for Violators or Intruders—needs to be designed and implemented. Similar to Ethereum's version of implementation for their “Proof-of-Stake” consensus protocol called Casper, this proprietary A.I.-Blockchain-driven Network [ABN] will utilize an algorithm that can set some circumstances under which a bad actor is made to lose economically under a penalizing decision.

Conclusive economic qualification is accomplished by requiring validators to submit “Deposits” (Protocol Tokens) to participate, and confiscating their “Deposits” as penalty if the protocol determines that they acted in some way that violates some set of rules (“Slashing Conditions”: circumstances, conditions or laws that Users are not supposed to break and must abide by).

Essentially, this fail-safe feature will be a security deposit protocol that relies on an economic consensus system. Nodes (“Validators” or “Forgers”) must pay a security deposit in order to be part of the consensus for the “new-blocks” verification and creation processes.

The protocol will then determine the specific amount of rewards received by the Forgers for its control over security deposits and its block-verification and/or block-creation services. If one Forger creates an “invalid” block or demonstrates malicious intent by violating the “Slashing Conditions”, his/her security deposit will be deleted, along with his/her privilege to be part of any network consensus going forward. In other words, the security system is based on the concept of “Betting”—reward their validators with money prizes if they win and penalize them with money losses if they lose, together with each chain that the validators have bet on.

Hence, the underlying mechanics of the other node-bets leave positive feedback that further accelerate consensus and promote the overall integrity of the blockchain network.

Advantageously, the tokens may be created using blockchain technology (asymmetric cryptography); and may be purchased in exchange for conventional money (e.g. various subscriptions—yearly, monthly, on-demand, etc.) in predetermined lots or as earned rewards awarded by a rewards module for behaviour on the platform (e.g. portfolio performance, social media popularity/influence, gaming score, etc.).

Interactions with Ecosystem

In addition, advantageously, the interactions of the device of a registered user with his/her own personalized A.I. Model & Machine Learning Module with regards to accessing particular information about specific financial instruments and portfolios are captured and logged in the cloud database (centralized data store 54).

Advantageously, this information could be captured by a data collection module and stored on a centralized data store 54 with specific records for each user, or in an alternate embodiment on an underlying decentralized & distributed ledger.

It would be appreciated that the data collected on each specified user could be segmented into a specific predetermined time period, for example one day, one week or one month.
Asset Query or Interaction Frequency with specific Features/Criteria [Rate/Count for “Asset Features” such as: Market Capitalization, Volatility, Trading Volume, Sector/Industry, Financial Metrics, etc.]. It would be appreciated by a person skilled in the art that similar metrics other than those listed could also be used without departing from the scope of the present disclosure.

By way of non-limiting example, the repeated access by a specified user to information published on a commercially available news source (such as e.g. Yahoo finance) for certain financial metrics about a specific stock AAPL may be recorded and stored by the user's own personalized A.I. Model & Machine Learning Module located on the centralized data server, and taken as indicating an interest by the specified user in the specific financial metrics of the specific investable instrument, for example the P/E ratio of Apple stock.

### Ranking of Assets: Asymmetric Transmogrification Optimization Matrix

A variety of approaches to ranking assets may be utilized by machine learning conducted by the data analysis and pattern recognition modules comprising one or more processors without departing from the scope of the present disclosure. An example of such techniques include techniques known as “Fractional Stochastic Rectification/Distillation” may be utilised for distillation & ranking of the global asset-universe based on user-defined input criteria (investment preferences & risk tolerances) to isolate and extract “user-matching” assets, via algorithms and methodologies that manipulate a series of asset data-matrix parameters including both the two key stochastic metrics as described below:

(a) Stochastic Volatility,
(b) Stochastic Sharpe-Ratio.
“FRACTIONAL STOCHASTIC RECTIFICATION / DISTILLATION”:
SAMPLE SIZE “N” of PERIOD-Z = ROUNDUP[(Z ÷ 12) * 256]
DAILY Asset Returns = R_{T} = [P_{T} ÷ P_{T-1}] − 1, for EACH Day “T” in Sample Size “N” (T ∈ N),
where P_{T} = Asset Price on Day “T”
Standard Deviation of DAILY Asset Returns [for Investment Horizon Z] = σ_{z} = √{ [Σ (R_{T} −
μ_{z})²] ÷ N }
Standard Deviation of PERIOD-Z Asset Returns = Φ_{z} = √[(Z ÷ 12) * 256] * σ_{z}
a) NUMERICAL VOLATILITY SEQUENCING [by “Assets”]: [“FRACTIONAL” Filtration-
Distillation Mechanism]
SORT “Asset-Class” Group in Ascending Numerical-Order of “Period-Z Standard Deviations”
[Φ_{z}(A)], for ALL Assets “A” in “Asset-Class” Group
If Φ_{z}(A) ≤ V [where V = Average %-Price Movement Acceptable], then ADD ASSET “A” to
ASSET-LIST “D”
b) “NUMERICAL SHARPE-RATIO SEQUENCING” [by “Assets”]: [Ranking Methodology]
Mean of DAILY Asset Returns [for Investment Horizon Z] = μ_{z} = [Σ R_{T}] ÷ N
Mean of PERIOD-Z Asset Returns = Π_{z} = [(Z ÷ 12) * 256] * μ_{z}
SHARPE-RATIO of PERIOD-Z [Ψ_{z}] = Π_{z} ÷ Φ_{z}
RANK ASSET-LIST in Descending Numerical-Order of “Period-Z Sharpe-Ratios” [Ψ_{z}(A)], for
ALL Assets “A” in ASSET-LIST “D” (A ∈ D)
Ψ_{z}(MAX) = MAX[Ψ_{z}(A)], for ALL Assets “A” in ASSET-LIST “D” (A ∈ D)
“SCORE” of ASSET “A” [Ω_{z}(A)] = [Ψ_{z}(A) ÷ Ψ_{z}(MAX)] * 100, for EACH Asset “A” in
ASSET-LIST “D” (A ∈ D)
DISPLAY “Ranked” ASSET-LIST with “SCORES” [Ω_{A}(A)]

Advantageously, this analysis is performed by a statistical/stochastic machine learning module 72 which comprises a generic Machine Learning Model (such as an “Artificial Neural Network” Model, a “Non-Linear Programming & Optimization” Model, etc.) which is continuously updated and which is configured to generate a score for each investable financial instrument by generating weightings across a plurality of objective parameters including Fundamental data (“Financial Metrics”: Price-to-Earnings Ratio [P/E], Price-to-Sales Ratio [P/S], Price-to-Book Ratio [P/S], Earnings-per-Share [EPS], Liquidity ratios, Debt ratios, dividend yield, etc.) and Technical Data (“Price-Action Metrics”: performance return, stochastic Volatility [time-varying/time-dependent price fluctuations], stochastic Sharpe ratio [time-varying/time-dependent risk vs. reward], Statistical Moving Averages [SMA], Stochastic Oscillators [SO], Momentum Indicators [MI], Convergence-Divergence indicators [CDI], Relative Strength Index [RSI], etc.).

An objective score for each potentially investable instrument can be generated and this information can continuously be updated in an ongoing process at predetermined time intervals by intaking and updating data.

A predetermined threshold may be set to yield the Top-20/50/100 etc. scoring assets according to the objective data provided for the specified user.

### Machine Learning & Deep Learning Applications Model

The top scoring assets may be further refined by the operation of a subjective machine learning module 74 of the present disclosure which is configured to use a model which is continuously & dynamically variable in nature.

Advantageously, the models employed consist of:
Multivariate Data-Analysis
Continuously changing number of input variables contingent upon the social interaction data and behavioral usage patterns derived from the informational interaction data.
Heuristic Simulation
Trial-&-Error based process by definition does not rely on a fixed “static” model, therefore the analytical learning network is continuously revised in real-time with updated input data, e.g. two different users with identical asset selections and risk-reward preferences input-data may be given completely different asset allocation output-solutions, subject to their individual interactions and behavioral usage patterns.

It is possible to further train the models used in the present disclosure to detect nuances in characteristics (e.g. stochastic metrics, asset fundamental valuations, etc.) that identify optimal financial Investments and infer optimal portfolio asset allocations.

Persons skilled in the art may be familiar with Google's “Google Brain” project, where the Target identity is the “Cat”. In the case of Grant Van Horn's iNat initiative, the target identity is the “Bird”.

Similarly, in order to assimilate Google's Neural Networks with the neural networks of the present disclosure, these target identities can be easily replaced with the present relevant targets of interests:
“Cats” [symbol] “Optimal Financial Investments”
“Birds” [symbol] “Optimal Portfolio Asset Allocations”

However, given the complexities of the underlying target identities (financial assets and investment portfolios) within present disclosure certain adjustments and customizations need to be made to the deep learning process employed.

In the case of plants and animals, each “species” is distinctly defined via images that can be used by the neural network to learn and deduce patterns for recognition.

By contrast, with financial assets and investment portfolios of the present disclosure, there is no clear-cut definition of what constitutes an “optimal financial investment” and what constitutes an “optimal portfolio asset allocation”.

Hence, these Target Identities underlying the model of the present disclosure need first be defined before they can be inputted into the neural network to undergo deep learning, but ironically such “definitions” are exactly the answers to be outputted from the entire machine learning process. This seemingly circular logic can be resolved however via a “2-Stage Bootstrap Process”.

First-Stage of the “2-Stage Bootstrap Process” involves using the model's proprietary stochastic-algorithms to generate a Heuristic Definition of the Target Identities based on empirically observed data, in the form of a Conditional Statement that utilizes a stochastic-metric called the A-SCORE [A_{A}=“Asset”-Score and A_{P}=“Portfolio”-Score].

Specifically, the Heuristic Definitions will be delineated as follows, with X and Y being empirically determined threshold-values derived from the model's stochastic-algorithms that perform analytics to isolate the “Top-Percentile” of Optimal Assets and Optimal Portfolios with the highest A-SCORES (at a point in time):
“Optimal Financial Investments”: A_{A}>X
“Optimal Portfolio Asset Allocations”: A_{P}>Y

A plurality of methods or techniques may be used to “initialize” the bootstrapping process, most of which will be empirically-determined given the complex nature and definition of the underlying random variable (i.e. “Quality” of an Asset or Portfolio) being measured or computed, such as the following “Initializing” algorithm which is outlined below by way of non-limiting example:

● Randomly select a “Historical Time-Period”, e.g. Past 12 Months
● Calculate A_{A}(i) = “Asset”-Score for ALL Assets “i” (for the corresponding
“Historical Time-Period”, e.g. Past 12 Months), where 1 ≤ i ≤ K and K = Total Number of
Assets in the Asset-Universe
● Randomly pre-define a percentage-value for “Top-Percentile of Assets”, e.g. 30%
● Numerically Sequence/Rank ALL Assets by A_{A}(i) = “Asset”-Score in Descending
Order
● Heuristic Definition “X”: “Optimal Financial Investment”
A_{A}(x)-Score Threshold = X = “Asset”-Score of Asset with Ranking Value of “0.3 x K”
= A_{A}(0.3K), e.g. if K = 1000 Assets, then X = A_{A}(300) = “Asset”-Score of Rank-300th
Asset
● Calculate Aₚ(j) = “Portfolio”-Score for ALL Portfolios “j” (for the corresponding
“Historical Time-Period”, e.g. Past 12 Months), where 1 ≤ j ≤ L and L = Total Number of
Portfolios in the Portfolio-Universe
● Randomly pre-define a percentage-value for “Top-Percentile of Portfolios”, e.g. 15%
● Numerically Sequence/Rank ALL Portfolios by Aₚ(j) = “Portfolio”-Score in
Descending Order
● Heuristic Definition “Y”: “Optimal Portfolio Asset Allocation”
Aₚ(y)-Score Threshold = Y = “Portfolio”-Score of Portfolio with Ranking Value of
“0.15 x L” = Aₚ(0.15L), e.g. if L = 100 Portfolios, then Y = Aₚ(15) = “Portfolio”-Score
of Rank-15th Portfolio

Second-Stage of the “2-Stage Bootstrap Process” requires randomly selecting N samples of “Optimal Financial Investments” and M samples of “Optimal Portfolio Asset Allocations” that fulfil the above criteria, then passing them through the Neural Network for 1st-iteration of Deep Learning to distinguish differences and correlate associations,

This is used to refine the individual categorical samples until such samples narrow down to isolated unique subsets, n and m respectively, that possess true correlations representing each of those categories (“Species”)—i.e. when the repeated iterations of Training-vs.-Validation “curve-fitting” process achieves an error-bias value below a certain pre-defined threshold tolerance level and the resultant “bootstrapped-trained” A.I. Model is acceptable for “Deep Learning Initiation”.

The n samples of “Optimal Financial Investments” and m samples of “Optimal Portfolio Asset Allocations” are in actual fact the resultant Bootstrapped Target Identity Datasets that generated the “Bootstrapped-Trained” A.I. Model to be introduced into the Neural Network for initiating the 2nd-iteration of Deep Learning which now uses the Entire Asset-Universe & Entire Portfolio-Universe as the “Training-vs.-Validation” sample data sets for the Machine Learning algorithm.

The A.I. Model is thus learning from the “True Definitions (Bootstrapped)” of Optimal Financial Investments and Optimal Portfolio Asset Allocations.

Once the 2nd-iteration of Deep Learning via the Neural Network is completed, the resultant “Final-Optimized” A.I. Model will be ready for use in the general identification of Optimal Financial Investments [N′] and Optimal Portfolio Asset Allocations [M′] (at the “Species” level) from random asset and portfolio samples from the entire Asset-Universe and Portfolio-Universe for the specified user.

Advantageously, the A.I. model can be continuously updated and revised with information received from the social network interaction data and informational interaction data. In this way the AI Model is constantly updated and modified for each user on an ongoing basis according to the specific interactions of that user and consequent informational and social interaction data, processed through the modules hereinbefore described.

However, just as there are different “Sub-Species” of Cats and Birds, there are likewise K different “Types” of Optimal Financial Investments [N′ₖ: 1≤k≤K] and Optimal Portfolio Asset Allocations [M′ₖ: 1≤k≤K], when there are K different Users on the Platform. In general, the follow mathematical conditions hold in the “Sub-Species” A.I. Model:

$${N}^{′} < \sum {N}_{k}^{′} = {N}_{1}^{′} + {N}_{2}^{′} + … + {N}_{K}^{′} ( k ∈ K and {N}_{k}^{′} ⊆ {N}^{′} ) \\ {M}^{′} < \sum {M}_{k}^{′} = {M}_{1}^{′} + {M}_{2}^{′} + … + {M}_{K}^{′} ( k ∈ K and {M}_{k}^{′} ⊆ {M}^{′} )$$

Hence, by application of Neural Network for distinguishing Bird “Sub-Species”, further iterations of enhanced Deep Learning with techniques similar to Fine-Grain Image Classification, using each User's custom “Profile” data as additional input into the Neural Network, will allow pattern recognition and identification of optimal financial investments [N′k] and optimal portfolio asset Allocations [M′k] on a Per-User basis (at the “Sub-Species” level) from random samples derived from in the general universe of Assets and Portfolios.

Examples of potentially applicable machine learning techniques which can be used to generate the models included Iterative Non-Linear Regression, Optimization, Data Mining, Non-Linear Programming, Artificial Neural Networks, Random Forest, Naïve Bayes, K-means Clustering, etc.) to generate an “ideal optimum A.I. model” unique to each specified user at a specific moment in time with continuously changing input variables determined by each user's behavioural usage and social interactions.

Reference is made to FIG. 1d in which an exemplary representation of the algorithm used in training the machine learning schematic of FIG. 1c is depicted.

As depicted in step 1 100, the Social network is initiated with “K users”; and the ecosystem is initiated.

Next in step 2, 110, the user's behavioural data is collected including input preferences and various interaction factors in the ecosystem as a matrix of variables.

At step 3, 120 customised AI model analytics and portfolio rankings are arranged.

As part of step 3, at step 122 an AI model is generated for the “k”th user using the set of behavioural variables captured in step 2.

Various asset scores are generated at step 124 for all assets and especially for all “I” assets which are applicable for user “K”.

An aggregate of these asset scores are generated as a portfolio score for the assets in various portfolio's q of user “K”.

Next, at step 4, 130, a machine learning algorithm for iteration “j” consolidates the interaction data in the ecosystem and social network.

In particular, at step 132, the user input preferences and interaction factors are updated using the aggregated user behavioural information for user the specific user “k” in the ecosystem.

At step 134, machine learning method transforms the current machine learning model to reflect the modified model “j” which takes into account the aggregated user behavioural data as it pertains to the specific user “k” and the model associated therewith.

Finally, at step 136, all iterations of “j” models for all K users (i.e. the total number of users) within the platform are collected in a set Mk (j)

### Portfolio Construction

An “Optimum Portfolio Allocation” for each individual specific user may be generated using an exemplary algorithm executed in the Portfolio Optimization module 80. Advantageously, this algorithm may comprise two main stages comprising (1) Portfolio Performance Optimization, AND (2) Portfolio Construction Optimization.

Both of these stages and their respective proprietary algorithmic sequences are discussed further herein below.

“Portfolio Performance Optimization” is conducted by aggregating the assets to determine Optimum Portfolio Allocations using the following proprietary algorithm which consists of a sequence of proprietary stochastic techniques executed consecutively by the rankings module 78, operating together with the optimisation module 80.

### (A) Azeotropic Stochastic Rectification/Distillation [of “Assets”]

This process involves numerical volatility sequencing using Distillation-Boundaries synthetically produced by “Brute-Force” Allocation (“Asset-Bucketing”) via the methodology of using either
[i] Modular Arithmetic to evenly distribute Assets into Asset-Groups/Asset-Buckets.
OR
[ii] One-Way ANOVA/Paired T-Test (statistical hypothesis testing) of strength and competence of distinct Numerical Volatility Sequences for grouping of Assets by their individual “Stochastic Volatility” ranges/categories.

### (B) Monte Carlo Portfolio & Weight Simulation

[i] Asset-Bucket Unit & Weight Allocation
[ii] Asset Weight Allocation
[iii] Portfolio Market Value Simulation

As is known in the art, asset-allocation by “brute-force” combinatorics & permutations is determined by the Binomial Coefficient. Such an application algorithm has a computational complexity or running-time of O(n!) (“Factorial-Time”), where “n”=Number of Allocation-Units [Unit Weight=100%=n].

However, by limiting the number of “Allocation-Units” [=20 Units, Unit Weight=5%] & “Asset-Buckets” [2 Buckets≤AB≤5 Buckets] and using a heuristic approach to obtain “Optimal Portfolio Allocation” along the Efficient Frontier, subject to the User's MAXIMUM Risk Tolerance (V), the resultant effect is that the application algorithm running-time is constrained to a magnitude of O(n) (“Linear-Time”)=(24!)÷[(20!)(4!)]=10,626 Combinations/Iterations.

Furthermore, by eliminating the “Zero Allocation-Unit” Combinations (i.e. focusing on non-zero allocations), the Heuristics Running-Time “Upper Bound” can be reduced further to only a MAXIMUM of 3,876 Portfolio Combinations/Iterations, thus allowing feasibility and capability of the algorithm for deployment and scalability.

### (C) Portfolio-Performance Non-Linear Optimization & Maximization [PP-NLOM] (Asset Weights=Optimized/Customized): Fractional Stochastic Rectification/Distillation [OF “Portfolios”]

### Numerical Volatility Sequencing [FILTRATION Mechanism]—for “PORTFOLIOS”

[i]

### Filtering Algorithm of “Portfolio Behavior”

[ii] Isolation of Portfolios by “Stochastic Volatility”

### Numerical Sharpe-Ratio Sequencing [DISTILLATION Mechanism]—for “PORTFOLIOS”

[i]

### Purification Algorithm of “Portfolio Quality”

[ii] Isolation of Portfolios by “Stochastic Sharpe-Ratio”

### (D) “Switch-Gradient” Portfolio Optimization [SGPO]

Optimization Switch-Gradient Ratio [OSGR] is a proprietary stochastic metric designed specifically to be used in the Portfolio Optimization module 80 as depicted in FIGS. 1a-b for the below purpose:

“Optimum Portfolio Selection” Algorithm—Uses the Optimization Switch-Gradient Ratio [OSGR] proprietary stochastic metric to compare mathematically whether an improvement in Portfolio Return (by switching to “Maximum Return” Portfolio) is a worthwhile sacrifice vs. a degradation in Portfolio Quality (by abandoning “Maximum Sharpe-Ratio” Portfolio) based on a pre-defined threshold tolerance level as a benchmark boundary and ultimately selecting either ONE of the below Optimal Portfolio Allocations as the “Final Optimized Portfolio Solution” for the specific user:
“Maximum Sharpe-Ratio” Portfolio
OR
“Maximum Return” Portfolio

“Portfolio Construction Optimization” may be determined using any of the below variety of proprietary algorithmic techniques:

### (A) Portfolio-Value Non-Linear Optimization & Minimization [PV-NLOM] (Asset Weights=Optimized/Customized)

[i] Recommended Minimum Portfolio Value [RMPV]:
Round-Lot Portfolio Value Maxi-Minimization [RLPV-MM]
A proprietary algorithm which calculates the MINIMUM PORTFOLIO VALUE that can constitute a Portfolio with ALL the “Asset Weights” DEFINED BY THE USER [Optimized Customized] and is performed by the Portfolio Optimization module 80.
   [ii] Minimum Acceptable Portfolio Value [MAPV]:
Absolute-Error Boundary Simulation JAE-BS]
A proprietary algorithm which calculates the MINIMUM PORTFOLIO VALUE that can constitute a Portfolio with ALL the “Asset Weights” DEFINED BY THE USER [Optimized Customized] AND has a “Total Absolute Weight-Tracking Error” LESS THAN A PRE-DEFINED ERROR-TOLERANCE THRESHOLD (“Absolute Error Boundary”)—i.e. This proprietary algorithm MINIMIZES the “Portfolio-Weightings Discrepancies” WHILE ALSO MINIMIZING the “Total Portfolio Value” simultaneously and is performed by the processor of the Portfolio Optimization module 80.

### (B) Target Portfolio Value [TPV]

### Round-Lot Valuation [RLV]

An algorithm which calculates the NUMBER OF SHARES [FOR EACH ASSET] (while factoring in Odd Share-Lot Sizes depending on the corresponding stock exchange conventions) that can constitute a Portfolio with the TARGET “Portfolio Value” AND ALL the “Asset Weights” DEFINED BY THE USER [Optimized/Customized].

The outcome provided then is an optimized portfolio for the user representative of their individual subjective interests (determined based on a combination of factors such as the user's personal preferences and criterion for financial instruments and investments, platform usage data and behavioral patterns, Machine Learning model suggestions, interaction with the A.I. Model & A.I. Ecosystem, gamification data, social interaction with members of the social network, social media content, etc.) and with information resources on the ecosystem and objective criterion (e.g. quantitative data, performance metrics, fundamental financial metrics, etc.) of financial instruments, investments and portfolios supplied to the system.

### Gamification

Reference is now made to FIG. 1b in a further schematic embodiment of the present disclosure, in which an optional gamification module 94 is included which builds and enhances user engagement.

As depicted, the same components of FIG. 1a in FIG. 1b operate in substantially the same manner as described above, subject to modifications as detailed below.

The gamification aspect described herein provides additional user attribute information which can be used to enhance the specificity and accuracy of the subjective machine learning module 74.

A challenge response verification system is provided to recognize successful achievements on the platform, including participation in gamification aspects may also be included. In particular this rewards module 90 may incentivize user engagement by making payments of blockchain protocol based tokens to the winning individual accounts of registered users held on the network. Advantageously, the payments may be awarded by the rewards module 80 based upon operation and engagement of the user with the gamification module 94 as described below.

Three scores are envisaged including the following:

### (i) Portfolio Performance Score [A-Score]

An aggregate “Performance Metric” A-Score for measuring each platform user's Portfolio Performance Versus Risk relative to other users on the platform—determined by using ranking metrics and/or score brackets. Examples of such metrics include (but are not limited to):
PORTFOLIO SCORE Ranges [Score-Bracket based Payout]—e.g. 10 Rewards per 1.0 Point Increment in SCORE
TOP-100 Ranking [Ranking-Bracket based Payout]—e.g. 5 Reward per 10 Rank Improvement in TOP-100 Ranking
Ranking Chart Dominance [Progression-Rate based Payout]—e.g. 1 Reward per 10 Rank Improvement in TOP-100 Ranking per 1 Day
Chart Rank-Holding Duration [Frequency/Time based Payout]—e.g. 1 Reward per 10 Days Same Rank or Better in TOP-100 Users Ranking.

In an exemplary example of the use of the A-Score for a particular user, assume that User “X” has 10 different Portfolios with various “Asset Sector/Industry/Class” focuses—e.g. Technology, Mining, Real-Estate, Cryptocurrency, etc.

Hypothetically, assume that this User X has a high/strong score (overall) and/or a high/strong score (specifically) for “Technology” and “Cryptocurrency” focused portfolios.

The data collection module 50 is configured to collect the performance, risk and constituent data of User “X”, and this additional information is included by the subjective machine learning module 74 for User “X”, being reflected by increasing the weighting of the user interest categories for Technology and Cryptocurrency focused portfolios.

### (ii) Social Media Score [S-Score]

As a way of scoring and rewarding influence and engagement with other users on the platform, an exemplary S-Score for each user may be calculated; with behavior driven by incentivizing participation using an adjusted scale of rewards for various metrics or score brackets of measuring Social Media Activity, Community Popularity and Social Network Influence.

Examples of such metrics include (but are not limited to):
Profile Followers [Rate/Count based Payout]]—e.g. 10 Reward points per 1000 incremental followers of the user's profile
Portfolio Followers [Rate/Count based Payout]—e.g. 10 Reward points per 1000 Incremental Followers of one of the user's Portfolio
Watchlist Followers [Rate/Count based Payout]—e.g. 10 Reward points per 1000 Incremental Followers of one of the user's Watch list
Influencer Potential [Ratio of Followers-Following based Payout]—e.g. 1 Reward point per 10% increase in Followers-Following Ratio of User Profile
TOP-100 Ranking [Ranking-Bracket based Payout]—e.g. 5 Reward points per 10 Rank Improvement in TOP-100 Ranking
Ranking Chart Dominance [Progression-Rate based Payout]—e.g. 1 Reward points per 10 Rank Improvement in TOP-100 Ranking per 1 Day
Chart Rank-Holding Duration [Frequency/Time based Payout]]—e.g. 1 Reward points per 10 Days Same Rank or Better in TOP-100 Ranking

In an exemplary example of the use of the S-Score for a particular user, assume that User “X” has 10 different Portfolios with various “Asset Sector/Industry/Class” focuses—e.g. Technology, Mining, Real-Estate, Cryptocurrency, etc.

Hypothetically, assume that this User “X” has a large number of followers following his/her profile and/or portfolios for “Mining” and “Real Estate” focused portfolios.

Similarly, the data collection module 50 may be configured for collecting the social media data of User “X”, and this additional information is included by the subjective machine learning module 74 for User “X”, being reflected by increasing the weighting of the user interest categories for Mining and Real estate focused portfolios.

(iii) Gaming Score [G-Score]

As a way of scoring and rewarding influence and engagement with the platform, an exemplary G-Score for each user may be calculated; with behavior driven by incentivizing participation in “Investment Asset Portfolio-Related Games” using an adjusted scale of rewards for various metrics or score brackets for Completion of Particular Tasks, Game-Playing Performance, Gamer Profile Status, Gaming Community Popularity & Gaming Network Social Influence.
Puzzles & Memory-Matching Game: Target Hit-Rate [Ratio/Points based Payout]—e.g. 5 Reward per 1000 Points Increment or per 1 Stage/Level Clear in Puzzles & Memory-Matching Game
Asset Chart Game: Price-Action Predictions [Ratio/Points based Payout]—e.g. 5 Reward per 1000 Points Increment or per 70% Correct Price-Action Prediction per Asset Chart Game
Pro-Gamer Potential [Ratio of Followers-Following based Payout]—e.g. 1 Reward point per 10% Increase in Followers-Following Ratio of Gamer Profile
TOP-100 Ranking [Ranking-Bracket based Payout]—e.g. 5 Reward points per 10 Rank Improvement in TOP-100 Ranking
Ranking Chart Dominance [Progression-Rate based Payout]—e.g. 1 “Reward points per 10 Rank Improvement in TOP-100 Ranking per 1 Day
Chart Rank-Holding Duration [Frequency/Time based Payout]]—e.g. 1 Reward per 10 Days Same Rank or Better in TOP-100 Ranking

In an example, User “X” has played 100 different rounds of PUZZLES & MEMORY GAMES and 100 different rounds of ASSET CHART GAMES with various “Asset Sector/Industry/Class” focuses—e.g. Technology, Mining, Real-Estate, Cryptocurrency, etc.

User “X” has a high strong GAMING SCORE [G-SCORE] (overall) and/or a high strong SCORE-POINTS/HIT-RATIOS (specifically) for “Technology” and “Cryptocurrency” focused PUZZLES & MEMORY-MATCHING GAMES [e.g. 10,000 Cumulative Score-Points] and/or ASSET CHART GAMES [e.g. greater than 90% Average “Price-Action Prediction” Hit-Ratios].

Exemplary user performance in this gaming aspect is another data metric captured for the specific user profile, which may further be provided to the subjective machine learning layer to enrich the user profile of each user.

Engagement with the platform overall can in this way further be enhanced between and amongst the users, by providing relative performance feedback and/or direct rewards associated with the performance of the specified task—whether the task is overall asset/portfolio performance, performance of various social tasks on the platform, or completion of certain games.

Rewards for specific aspects of performance paid in reward points may be redeemed by converting reward payments on the system for credits as applicable via the rewards module 90. Optionally, in an embodiment the rewards module may determine based upon points awarded by the gamification module for a specified user for performance of predetermined tasks specific awards on the platform. Alternatively, users may also be able to purchase points according to a sliding scale of points using the rewards module; for example by providing proof of the payment of an amount of a predetermined currency (e.g. Hong Kong Dollar, US dollar etc.) from an account of the specified user to the overall platform account or potentially the account of the user on the platform from which the funds may be drawn down.

### Data Collection and Data Base Repository

For clarity of explanation, in some instances the present technology may be presented as including individual functional blocks including functional blocks comprising devices, device components, steps or routines in a method embodied in software, or combinations of hardware and software.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, Universal Serial Bus (USB) devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A computer based method of generating for a specified user an optimised portfolio comprising a plurality of investable financial instruments: the method comprising
acquiring via a user device, criterion from the user for selecting one or more financial instruments from a plurality of investable financial instruments on the platform,
capturing by a network device, social interaction data characterising interactions of the user with other registered users of the platform having investable financial instruments associated therewith for a predetermined period;
acquiring by a network device, informational interaction data characterising interactions of a device of a registered user with information about one or more of the plurality of investable financial instruments within the predetermined period;
continuously ranking by a first machine learning model operating on a network device each of the plurality of potentially investable financial instruments of the platform according to predetermined objective criteria by generating a first score;
generating by a second machine learning model of the platform a portfolio comprising a plurality of investable financial instruments for the user by combining the first score for each investable financial instrument with the criterion, social interaction data and informational interaction data of the user.

2. The computer based method of generating for a specified user an optimised portfolio comprising a plurality of investable financial instruments according to claim 1 wherein the informational interaction data of the specified user is derived by monitoring one of more of the parameters selected from a group comprising: searches conducted for a financial instrument by the specified user, and/or time spent by the specified user on specific parameters associated with one or more financial instruments selected from the group comprising one or more of market capitalization, volatility, trading volume, sector/industry, financial metrics.

3. The computer based method of generating for a specified user an optimised portfolio comprising a plurality of investable financial instruments according to claim 1 wherein the social interaction data comprises data selected from rate/count over a predetermined time period of interactions with any data selected from the group comprising platform asset(s), portfolio(s), watchlist(s), social interactions with other registered user profiles.

4. The computer based method of generating for a specific user an optimised portfolio comprising a plurality of investable financial instruments according to claim 3 wherein the interactions comprise clicks, adds, shares, following or followed updates.

5. The computer based method of generating for a specified user an optimised portfolio comprising a plurality of investable financial instruments according to claim 1 wherein the second machine learning model is further configured to receive data from a gamification module incentivising participation in a plurality of tasks by awarding points to an account associated with the user.

6. The computer based method of generating for a specified user an optimised portfolio comprising a plurality of investable financial instruments according to claim 5 wherein the plurality of tasks are selected from the group comprising one or more of relative improvement in performance of portfolio to other users, absolute performance of portfolio, relative improvement in social media engagement to other users, absolute improvement in social media engagement relative to other users, and performance in one or more games.

7. The computer based method of generating for a specified user an optimised portfolio comprising a plurality of investable financial instruments according to claim 6 wherein one or more of the social interaction data and informational interaction data are stored on an underlying decentralized distributed ledger.

8. The computer based method of generating for a specified user an optimised portfolio comprising a plurality of investable financial instruments according to claim 7 wherein tokens on the underlying decentralized distributed ledger are updated by a rewards module according to points awarded by the gamification module for a specified user for performance of predetermined tasks.

9. The computer based method of generating for a specified user an optimised portfolio comprising a plurality of investable financial instruments according to claim 7 wherein tokens on the underlying decentralized distributed ledger are updated by a rewards module upon a corresponding payment of an amount of predetermined currency from an account of the user.

10. The computer based method of generating for a specified user an optimised portfolio comprising a plurality of investable financial instruments according to claim 1 wherein one or more of the social information data and/or informational interaction data of the user are encrypted.

11. A system for generating for a specified user an optimised portfolio comprising a plurality of investable financial instruments; the system comprising
an interface module for generating an interface for acquiring via a user device, criterion from the specified user for selecting one or more financial instruments from a plurality of investable financial instruments on the platform,
a social network module of a network device for capturing social interaction data characterising interactions of the user with other registered users of the platform having investable financial instruments associated therewith for a predetermined period;
an informational interaction data module configured for capturing interactions of a device of the user with information about one or more of the plurality of investable financial instruments within the predetermined period;
a first machine learning model operating on a network device for continuously ranking each of the plurality of potentially investable financial instruments of the platform according to predetermined objective criteria by generating a first score;
a second machine learning model operating on a network device for optimising a portfolio comprising a plurality of investable financial instruments for the specified user by combining the first score for each investable financial instrument with the criterion, social interaction data and informational interaction data of the user.

12. The system for generating for a specified user an optimised portfolio comprising a plurality of investable financial instruments according to claim 11 wherein the informational interaction data module captures interactions of the specified user by monitoring one of more of the parameters selected from a group comprising: searches conducted for a financial instrument by the specified user, and/or time spent by the specified user on specific parameters associated with one or more financial instruments selected from the group comprising one or more of market capitalization, volatility, trading volume, sector/industry, financial metrics.

13. The system for generating for a specified user an optimised portfolio comprising a plurality of investable financial instruments according to claim 11 wherein the social network module is configured for capturing social interaction data wherein the interactions are selected from the group comprising rate/count over a predetermined time period of clicks, adds, shares, following, followers of any data selected from the group comprising one or more of platform asset(s), portfolio(s), watchlist(s), social media, social network and user follower-following.

14. The system for generating for a specified user an optimised portfolio comprising a plurality of investable financial instruments according to claim 11 wherein the second machine learning model is further configured to receive data from a gamification module incentivising participation in a plurality of tasks by awarding points to an account associated with the user.

15. The system for generating for a specified user an optimised portfolio comprising a plurality of investable financial instruments according to claim 14 wherein the plurality of tasks are selected from the group comprising one or more of relative improvement in performance of portfolio to other users, absolute performance of portfolio, relative improvement in social media engagement to other users, absolute improvement in social media engagement relative to other users, and performance in one or more games.

16. The system for generating for a specified user an optimised portfolio comprising a plurality of investable financial instruments according to claim 11 wherein one or more of the social information data and/or informational interaction data of the user are encrypted and stored on a distributed ledger.

17. The system for generating for a specified user an optimised portfolio comprising a plurality of investable financial instruments according to claim 16 wherein one or more tokens on the distributed ledger are updated by a rewards module according to points awarded by the gamification module to a user for performance of predetermined tasks.

18. The system for generating for a specified user an optimised portfolio comprising a plurality of investable financial instruments according to claim 16 wherein one or more tokens are updated on the distributed ledger by a rewards module upon a corresponding payment of an amount of predetermined currency from an account of the user.
